(19) United States
(12) Patent Application Publication
(10) Pub. No.: US 2026/0094378 A1
(43) Pub. Date: Apr. 2, 2026

(54) EQUIPMENT MANAGEMENT APPARATUS, EQUIPMENT MANAGEMENT METHOD, AND RECORDING MEDIUM

(71) Applicant: PACIFIC CONSULTANTS CO., LTD., Tokyo (JP)

(72) Inventors: Akihiko YAMANAKA, Tokyo (JP); Makoto YUMINE, Tokyo (JP)

(73) Assignee: PACIFIC CONSULTANTS CO., LTD., Tokyo (JP)

(21) Appl. No.: 19/142,276

(22) PCT Filed: Jan. 15, 2024
(86) PCT No.: PCT/JP2024/000805

§ 371 Date: Jun. 23, 2025

(30) Foreign Application Priority Data
Jan. 20, 2023 (JP) 2023-007171

(51) Int. Cl. G06T 19/00

(52) U.S. Cl. CPC G06T 19/00

(57) ABSTRACT

An equipment management apparatus according to the present invention includes a recording unit, a display unit, and a display control unit. The recording unit records equipment information which includes nameplate data, and point cloud data which is a set of points each having a three-dimensional coordinate. The display control unit acquires projection information which is a condition for two-dimensionally converting the point cloud data so as to control display of the point cloud data on the display unit, and controls display of the nameplate data on the display unit. The display control unit controls display of the nameplate data on the display unit based on a position at which a point in point cloud data, with which the nameplate data is associated, is displayed on the display unit, or controls display of the nameplate data on the display unit based on a three-dimensional coordinate with which the nameplate data is associated.

### TECHNICAL FIELD

The present invention relates to an equipment management apparatus, an equipment management method, an equipment management program, and a recording medium for managing management-target equipment which is equipment to be managed.

### BACKGROUND ART

A technology of Patent Literature 1, for example, is known as an equipment management technology for managing management-target equipment, which is equipment to be managed, by using three-dimensional point cloud data of a space including the management-target equipment. Utilizing three-dimensional point cloud data as a platform system for infrastructure management is a major change which lowers a hurdle to conduct three-dimensional infrastructure management because it can reduce a cost of constructing three-dimensional base maps compared to conventional photographic images and modeling images and accordingly expands the use of three-dimensional images. Thus, the utilizing of three-dimensional point cloud data provides significant benefits.

### PRIOR ART LITERATURE

### Patent Literature

Patent Literature 1: Japanese Patent Application Laid Open No. 2022-038803

### SUMMARY OF THE INVENTION

### Problems to be Solved by the Invention

However, in a system which utilizes three-dimensional point cloud data as a base map for infrastructure management platforms, problems such as a problem in drawing speed caused by an extremely large data volume cause great stress for users in working, which are obstacles to widespread use of the system.

The present invention has been made in light of these circumstances, and is aimed to improve operability of systems for managing management-target equipment such as infrastructure facilities by using three-dimensional point cloud data.

### Means to Solve the Problems

An equipment management apparatus according to the present invention is an equipment management apparatus for managing management-target equipment, which is equipment to be managed, by using point cloud data of a space including the management-target equipment. The equipment management apparatus according to the present invention includes a recording unit, a display unit, and a display control unit. The recording unit records equipment information which includes nameplate data for identifying management-target equipment existing in the space and attribute data indicating an attribute of the management-target equipment, and the point cloud data which is a set of points each having a three-dimensional coordinate. The display unit displays point cloud data and nameplate data. The display control unit acquires projection information which is a condition for two-dimensionally converting the point cloud data, so as to control display of the point cloud data on the display unit in accordance with point cloud selection information and the projection information, and controls display of the nameplate data on the display unit. The recording unit records the nameplate data in a manner to associate the nameplate data to a point in the point cloud data or a three-dimensional coordinate. Further, when the nameplate data is associated with a point in the point cloud data, the display control unit controls display of the nameplate data on the display unit based on a position at which the point, with which the nameplate data is associated, in the point cloud data is displayed on the display unit. When the nameplate data is associated with a three-dimensional coordinate, the display control unit controls display of the nameplate data on the display unit based on a position at which the three-dimensional coordinate, with which the nameplate data is associated, is displayed on the display unit in accordance with projection information.

### Effects of the Invention

According to the equipment management apparatus of the present invention, nameplate data is associated with at least one point (a point in point cloud data or three-dimensional coordinate) corresponding to a management-target equipment in a state in which the point cloud data is treated as a single set. Accordingly, the point cloud data and equipment information are easily associated with each other. That is, three-dimensional point cloud data can be utilized as a platform system for infrastructure management without any processing. In terms of display, point cloud data is displayed in a desired range from a desired direction and displayed based on a point with which nameplate data is associated. This method allows easy access to displayed equipment in the equipment management apparatus in displaying, reducing stress on users. Thus, operability of a system for managing management-target equipment by using three-dimensional point cloud data can be improved.

### BRIEF DESCRIPTION OF THE DRAWINGS

FIG. 1 is a diagram illustrating a functional configuration example of an equipment management apparatus according to the present invention.

FIG. 2 is a diagram illustrating an example of a processing flow of association assignment.

FIG. 3 is a diagram illustrating an example of a processing flow in a configuration in which a display unit and a display control unit are provided.

FIG. 4 is a diagram illustrating an example of a processing flow in a configuration in which a display unit, a display control unit, and an association change unit are provided.

FIG. 5 is a diagram illustrating an example of a processing flow of the display control unit.

FIG. 6 is a diagram illustrating a state in which a room in which management-target equipment is arranged is displayed.

FIG. 7 is a diagram illustrating a state in which the room of FIG. 6 is displayed from an opposite side.

FIG. 8 is a diagram illustrating a state in which a vicinity of Blower No. 1 in FIG. 6 is displayed from a different line of sight.

FIG. 9 is a diagram illustrating a state in which density of the point cloud data in FIG. 6 is lowered.

FIG. 10 is a diagram illustrating a state in which a viewpoint is moved forward from FIG. 9.

FIG. 11 is a diagram illustrating a state in which nameplate data is selected and displayed.

FIG. 12 is a diagram illustrating an example in which a thickness of a frame surrounding nameplate data is changed depending on a distance.

FIG. 13 is a diagram illustrating a state in which only point cloud data in FIG. 6 at close distances is displayed.

FIG. 14 is a diagram illustrating a state in which only point cloud data in FIG. 8 at close distances is displayed.

FIG. 15 is a diagram illustrating a state in which only point cloud data at an intermediate part is displayed.

FIG. 16 is a diagram illustrating a state in which a point for associating nameplate data is changed.

FIG. 17 is a diagram illustrating a functional configuration example of a computer.

### DETAILED DESCRIPTION OF THE EMBODIMENTS

An embodiment according to the present invention will be described in detail below. Here, components having the mutually-same functions will be provided with the mutually-same reference characters and duplicate description thereof will be omitted.

### First Embodiment

First, problems can be specifically summarized as follows. If any of the following problems could be solved, improvement in operability of a system can be expected.
(1) On a three-dimensional display screen, facilities are drawn by point clouds in a single file per room, making it difficult to freely operate (moving operation such as straight ahead movement, backward movement, up and down movement, left and right movement, rotate, and so on) an image with an extremely large amount of data on the screen. In particular, due to the functionality of the system, data is taken into cache memory once and drawing processing is performed in the cache. Accordingly, when a processing power reaches its breaking point while continuously moving on the screen, a screen freeze state arises. When dealing with large amounts of data, frequent occurrence of the freeze state can be stressful for users.
(2) In terms of nameplates, a mechanism is employed which attaches a nameplate to point data, which can be visually recognized on the screen and constitutes a facility, on a plane (within a visual range of the screen), having problems such as a problem in that nameplates overlap and become difficult to be identified when there are many nameplates attached, a problem in that nameplates cannot be identified from directions other than a surface, to which the nameplates are attached, by screen operations, and a problem in that nameplates cannot be identified by perspective. This makes it difficult for users to immediately identify association between target equipment and a nameplate, which causes stress for the users. Therefore, in nameplate attachments, it is necessary to more naturally ensure an integrated operation system between search-target equipment and a nameplate.
(3) Further, because of the characteristics of three dimensions, as the number of pieces of equipment in a target facility is overcrowded, a space between the pieces of equipment becomes narrower. Therefore, when a distance between a viewpoint from which equipment is viewed and the equipment becomes closer, it becomes difficult to identify the equipment. The reason for this lies in characteristics of point cloud data. Point cloud data constitutes an object as a set of point data arranged at certain intervals (in a unit of mm). Therefore, when viewed up close, a space between points becomes transparent, making it difficult to identify individual objects. By viewing from a distance at and beyond a certain distance, gaps between the points are filled and individual objects can be identified. However, when viewing from a distance, if pieces of equipment are installed closed to one another, equipment in front of equipment desired to be viewed is viewed in an overlapping manner, making it difficult to visually recognize specific equipment. Thus, another problem is the difficulty in identifying individual pieces of equipment when pieces of equipment are installed closer to one another.

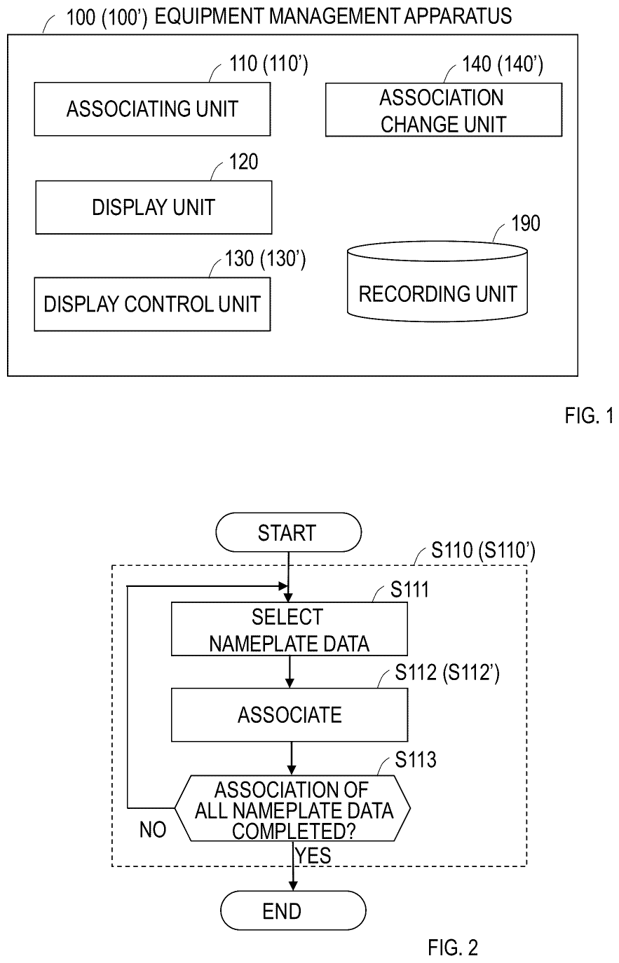

FIG. 1 illustrates a functional configuration example of an equipment management apparatus according to a first embodiment. An equipment management apparatus 100 of the first embodiment is an equipment management apparatus for managing management-target equipment, which is equipment to be managed, by using point cloud data of a space including the management-target equipment. The equipment management apparatus 100 includes at least a recording unit 190, a display unit 120, and a display control unit 130. The equipment management apparatus 100 may include an associating unit 110 and an association change unit 140. The processing of the associating unit 110 is part of processing for preparing to manage management-target equipment by the equipment management apparatus 100, and the processing may be executed by a user other than a user who manages the management-target equipment. Therefore, in a situation in which a user who only performs management of management-target equipment uses the equipment management apparatus 100, the associating unit 110 is not required to be provided. However, in this configuration, the recording unit 190 records information of a state in which the processing in the associating unit 110 is completed. The “information of a state in which the processing in the associating unit 110 is completed” will be described later.

The recording unit 190 of the equipment management apparatus 100 including the associating unit 110 records equipment information and point cloud data in an initial state. The equipment information includes nameplate data for identifying management-target equipment existing in a space and attribute data indicating an attribute of the management-target equipment. The point cloud data is a set of points having three-dimensional coordinates. “Space” is, for example, a room in which management-target equipment is located, and is a unit for collecting point cloud data, which is a set of points having three-dimensional coordinates by using a scanner or the like. “Nameplate data” refers to a name, a number, and so on for identifying management-target equipment, and may be, for example, a name easy for users to understand. “Attribute” is additional information about management-target equipment. Information required for management, such as a management number, installation location information, manufacturer, construction company, construction date, date of last maintenance, and dimensions, may be appropriately selected and used as attribute data. Three-dimensional coordinate is a coordinate which indicates a three-dimensional position expressed by, for example, an X coordinate, a Y coordinate, and a Z coordinate. However, the three-dimensional coordinate is not necessary to be limited to an orthogonal coordinate system using the X, Y, and Z coordinates, but a cylindrical coordinate system or a polar coordinate system may be used depending on shapes of a space and management-target equipment.

FIG. 2 illustrates an example of a processing flow of association assignment. The associating unit 110 associates nameplate data of management-target equipment included in point cloud data with at least one point corresponding to the management-target equipment, in accordance with an instruction of a user of the corresponding equipment management apparatus (S110). In step S110, the user first selects nameplate data (S111). Subsequently, the user selects a point from the point cloud data displayed on the display unit 120 so as to associate the nameplate data with the point (S112). At this time, three-dimensional point cloud data is displayed on the display unit 120 in a two-dimensionally-projected manner. Among the displayed points, there may be points close to and far from a viewpoint from which the two-dimensional display is viewed. Therefore, for example, the point to be selected for association may be the closest point which exists within a predetermined range from a position (position on a screen of the display unit 120) designated by the user using a mouse or the like. Here, “predetermined range” may be a range wider than the interval of the point cloud data. Steps S111 and S112 are executed with respect to nameplate data of all management-target equipment included in the point cloud data (S113). In principle, the number of points to be selected may be one. However, a plurality of points in the vicinity may be selected. When a plurality of points are selected, for example, the associating unit 110 may obtain an average coordinate of coordinates of the selected points so as to associate the average coordinate with the closest point or associate nameplate data with the average coordinate. Alternatively, taking into account a case where density of point cloud data is reduced to display the point cloud data on the display unit 120 as described below, a plurality of points may be selected so that any one of the plurality of selected points will be displayed.

The above-described processing is performed in the associating unit 110 and therefore, nameplate data of management-target equipment included in point cloud data is recorded in the recording unit 190 in a manner to be associated with at least one point corresponding to the management-target equipment, as “information of a state in which the processing in the associating unit 110 is completed”. That is, the recording unit 190 of the equipment management apparatus 100 free from including the associating unit 110 and the recording unit 190 of the equipment management apparatus 100 in which the processing in the associating unit 110 is completed record equipment information, which includes nameplate data for identifying management-target equipment existing in a space and attribute data indicating an attribute of the management-target equipment, and the point cloud data, which is a set of points having three-dimensional coordinates, and the nameplate data of the management-target equipment included in the point cloud data is associated with at least one point corresponding to the management-target equipment. In the present invention, it is sufficient for point cloud data to be a single set of points having three-dimensional coordinates, and there is no need to classify point cloud data for every management-target equipment. That is, nameplate data is associated with at least one point corresponding to management-target equipment in the state in which the point cloud data is treated as a single set. Thus, point cloud data and equipment information are easily associated with each other.

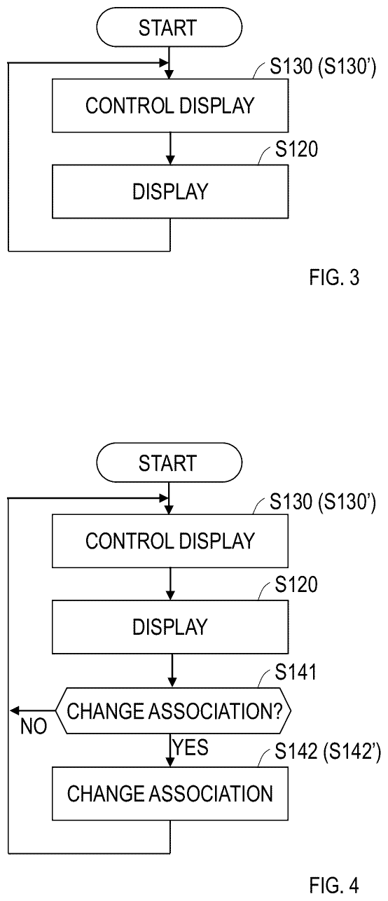

FIG. 3 illustrates an example of a processing flow in a configuration in which the display unit 120 and the display control unit 130 are provided. FIG. 4 illustrates an example of a processing flow in a configuration in which the display unit 120, the display control unit 130, and the association change unit 140 are provided. The display control unit 130 acquires projection information which is a condition for two-dimensionally converting point cloud data so as to control display of the point cloud data on the display unit 120 in accordance with the projection information, and controls display of nameplate data, which is associated with a point in the point cloud data to be displayed, on the display unit 120 based on the associated point (S130). The projection information may be information including, for example, a position of a viewpoint in a space (a viewpoint coordinate which is a three-dimensional coordinate of the viewpoint) and a line-of-sight direction which is a direction of a line of sight from the viewpoint. Point cloud data is two-dimensionally converted based on such projection information. The display unit 120 is provided with a display and so on and displays two-dimensionally converted point cloud data and nameplate data (S120). “Control display of nameplate data on the display unit 120 based on the associated point” means determining the position, at which the nameplate data is displayed, based on the position of the associated point on the display unit 120. For example, nameplate data may be displayed on the display unit 120 so that a specific position of the nameplate data overlaps with a point associated with the nameplate data. The nameplate data is displayed in this manner and therefore, it is easy for users to understand a correspondence relationship between management-target equipment and equipment information even though point cloud data is treated as a single set.

In the configuration in which the equipment management apparatus 100 is also provided with the association change unit 140, when association change is selected in a state in which point cloud data and nameplate data are displayed on the display unit 120 (S141), the association change unit 140 changes a point with which the nameplate data is associated to a point whose distance from the associated point in the three-dimensional coordinate is within a predefined distance (S142). The three-dimensional point cloud data is two-dimensionally converted (projected) and displayed on the display unit 120. Accordingly, points which are close on the display unit 120 may be far apart in a three-dimensional space. Even when a point with which nameplate data is associated is changed, the point needs to be changed to a point indicating the same management-target equipment. Therefore, the association may be changed among points whose distance in the three-dimensional coordinate is within a predetermined distance. The “predetermined distance” may be determined taking into account the dimensions of management-target equipment and a distance between adjacent points in point cloud data.

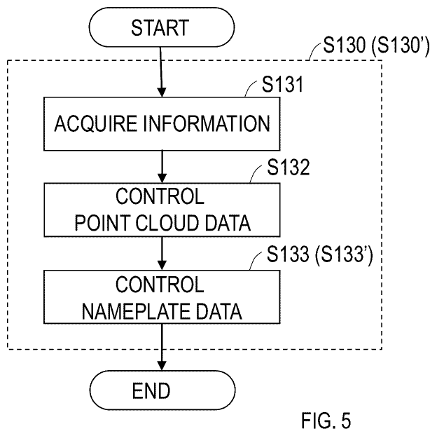

FIG. 5 is a diagram illustrating an example of a processing flow of the display control unit 130. The display control unit 130 acquires projection information which is a condition for two-dimensionally converting point cloud data (S131). The display control unit 130 controls display of the point cloud data on the display unit 120 in accordance with the projection information (S132). “Projection information” is a condition for two-dimensionally converting point cloud data. For example, the projection information may be information including a viewpoint coordinate, which is a three-dimensional coordinate of a viewpoint, and a line-of-sight direction, which is a direction of a line of sight from the viewpoint. Then, the display control unit 130 may two-dimensionally convert the point cloud data so as to represent an appearance viewed from the viewpoint in the line-of-sight direction. Further, the display control unit 130 controls display of nameplate data, which is associated with a point in the point cloud data to be displayed, on the display unit 120 (S133). The display control unit 130 displays the nameplate data as two-dimensional data so that the nameplate data is not hidden by the point cloud data. For example, the display control unit 130 two-dimensionally projects the point cloud data on the display unit 120 in step S132 and then overwrites the nameplate data, which is two-dimensional data, in step S133, thereby being able to display the nameplate data so that the nameplate data is not hidden by the point cloud data.

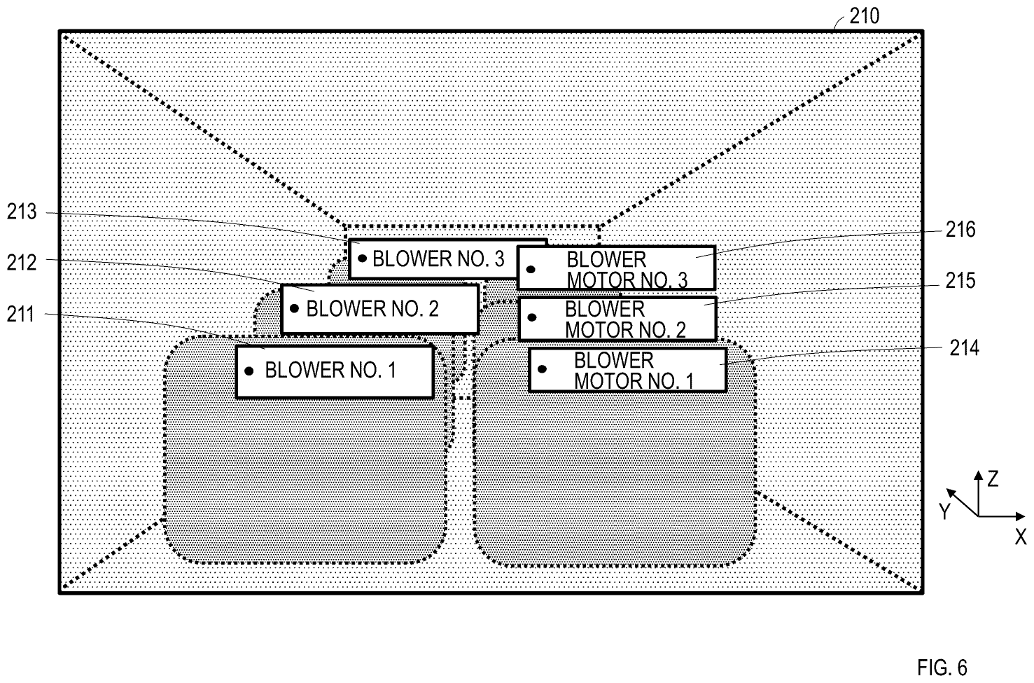

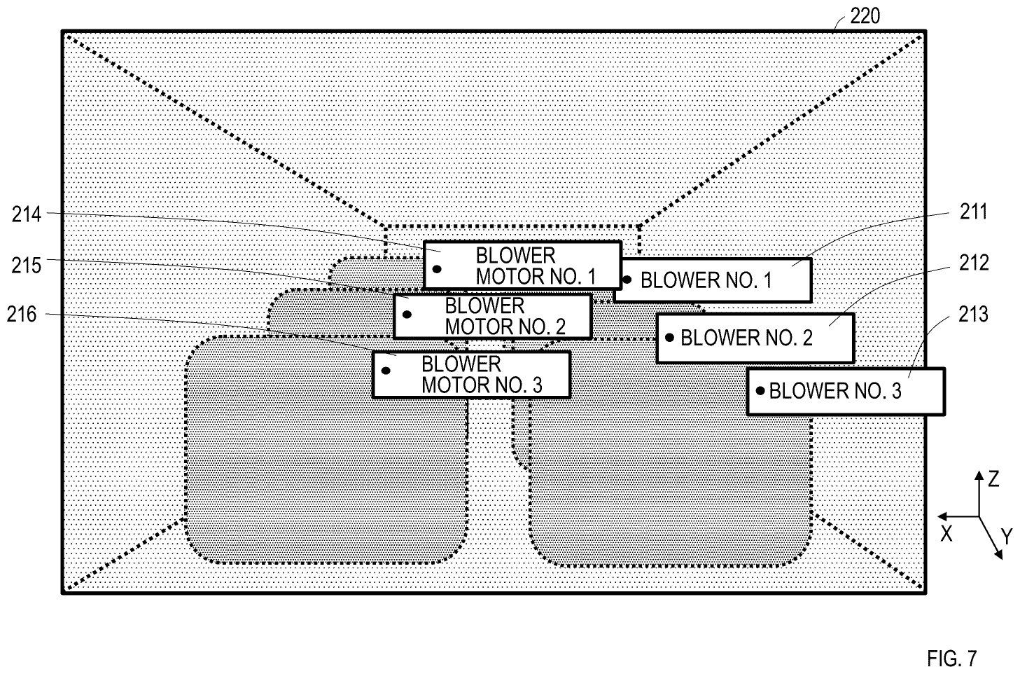

FIG. 6 is a diagram illustrating a state in which a room in which management-target equipment is arranged is displayed. FIG. 7 is a diagram illustrating a state in which the room of FIG. 6 is displayed from an opposite side. In FIGS. 6 and 7, “Blower No. 1”, “Blower No. 2”, “Blower No. 3”, “Blower Motor No. 1”, “Blower Motor No. 2”, and “Blower Motor No. 3” are located. It can be seen that nameplate data 211 to 216 are displayed as two-dimensional data so that the nameplate data 211 to 216 are not hidden by point cloud data 210 and 220.

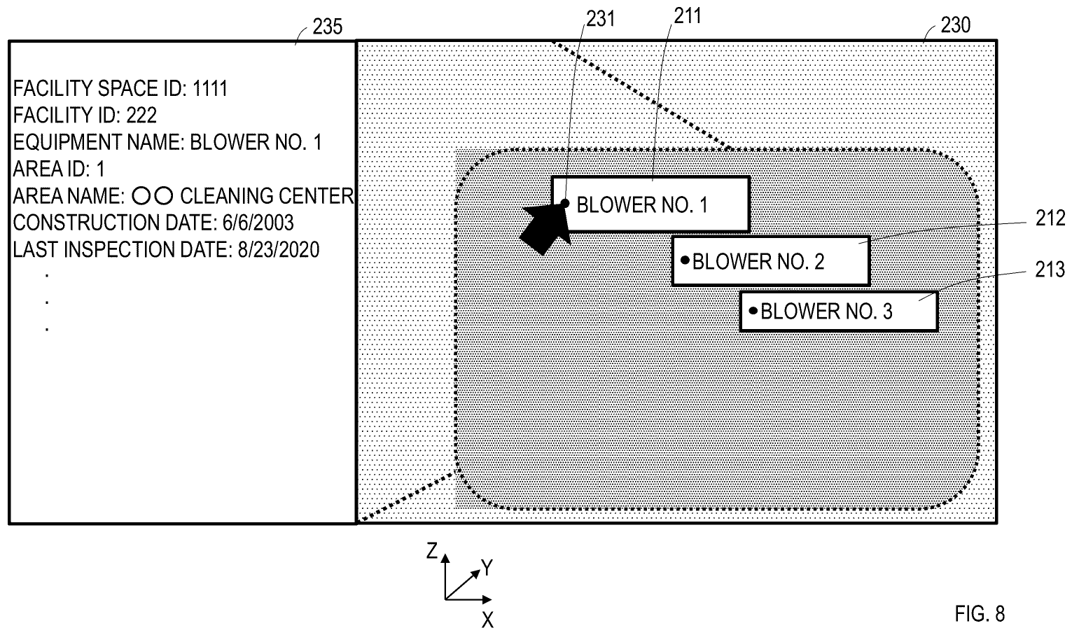

FIG. 8 is a diagram illustrating a vicinity of Blower No. 1 in FIG. 6 from a different line of sight. In point cloud data 230, only Blower No. 1 can be visually observed as management-target equipment, but the point cloud data of Blower No. 2 and Blower No. 3 are also projected two-dimensionally. Therefore, not only the nameplate data 211 but also the nameplate data 212 and 213 are displayed. FIG. 8 also illustrates a state in which attribute data 235 for Blower No. 1 has been displayed by clicking on point 231 of the nameplate data 211.

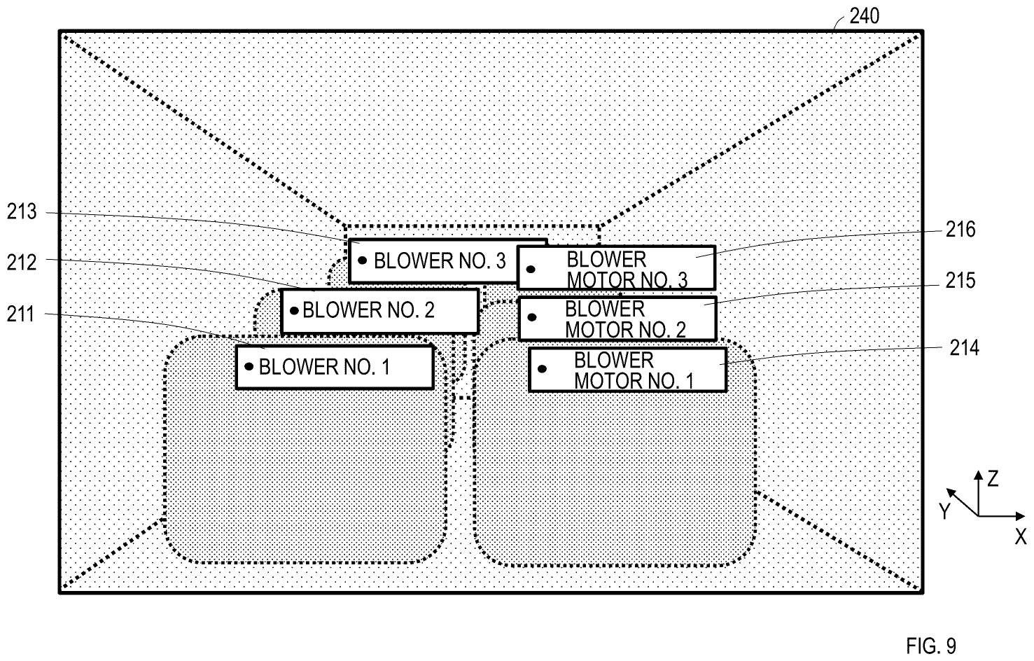

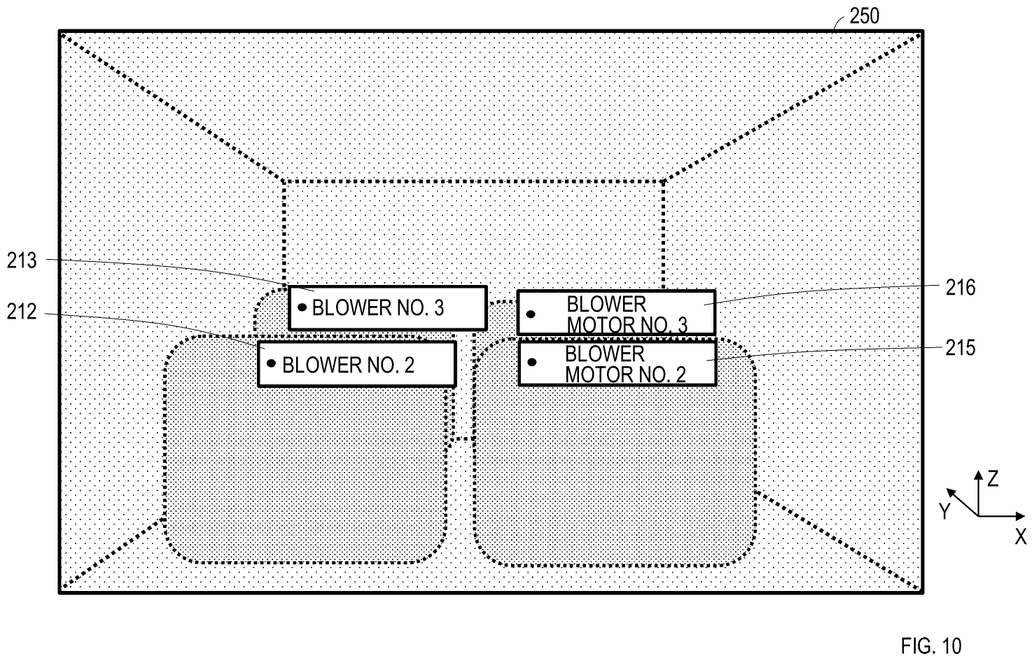

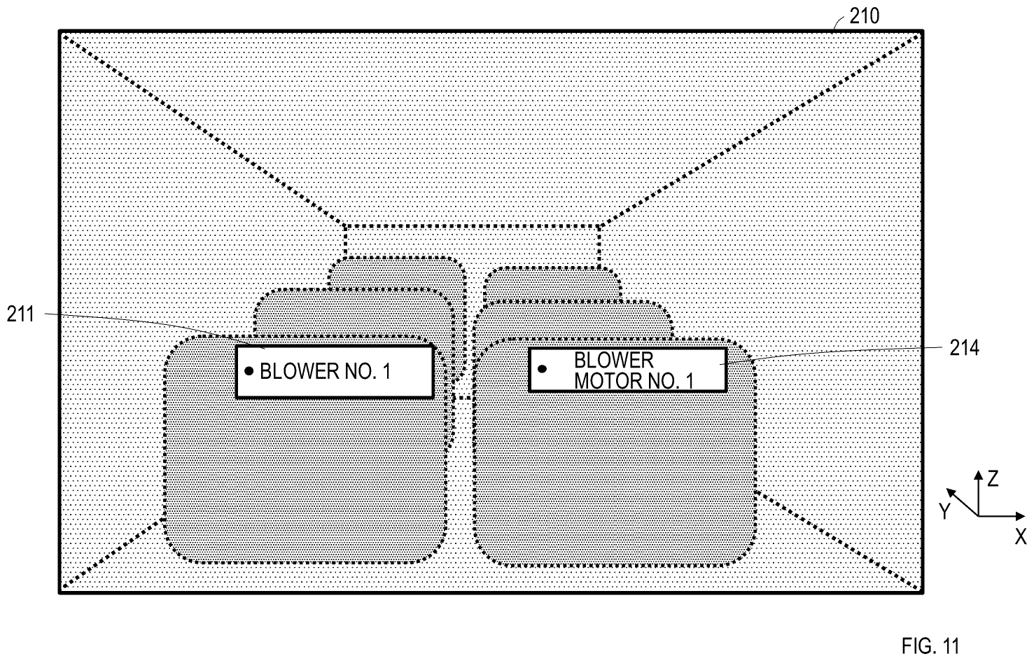

FIG. 9 is a diagram illustrating a state in which density of the point cloud data in FIG. 6 is lowered. When projection information is changed, the display control unit 130 may reduce the density of point cloud data to be displayed on the display unit 120 while ensuring that at least one of associated points is not omitted for each piece of nameplate data. It is necessary to perform the processing of two-dimensionally converting point cloud data when projection information is changed, which places a load on the processing of the display control unit 130. Taking into account the load on the processing, the density of point cloud data 240 may be appropriately changed to, for example, ¼ or 1/10 of the density of the point cloud data 210. Here, if all of the points associated with nameplate data are omitted, the nameplate data cannot also be displayed. Therefore, the density is controlled so as not to omit all of the points associated with nameplate data. For example, when there is only one point associated with certain nameplate data, the density is controlled so as not to omit the point. When there are a plurality of points associated with certain nameplate data, the density may be controlled so as not to omit any one of the points. Further, FIG. 10 is a diagram illustrating a state in which a viewpoint is moved forward from FIG. 9. In point cloud data 250 of FIG. 10, it can be seen that Blower No. 1 and Blower Motor No. 1 have disappeared from the display. The point cloud data of Blower No. 1 and Blower Motor No. 1 are not displayed and therefore, the nameplate data 211 and 214 are also not displayed. A processing load can be reduced in the processing of two-dimensionally converting a large amount of point cloud data, thereby being able to reduce a risk of the equipment management apparatus 100 being in a frozen state. As a result, stress on users can be reduced.

In step S131, the display control unit 130 may also acquire nameplate selection information which is a condition for selecting nameplate data which is to be displayed on the display unit 120. When nameplate selection information is also acquired, the display control unit 130 controls display of the nameplate data on the display unit 120 also in accordance with the nameplate selection information in step S133. FIG. 11 illustrates a state in which nameplate data is selected and displayed. The point cloud data 210 is the same as in FIG. 6, but only the nameplate data 211 and 214 are illustrated. For example, when point cloud data cannot be visually observed as in FIG. 8, it is possible to select not to display the nameplate data of management-target equipment which cannot be visually observed.

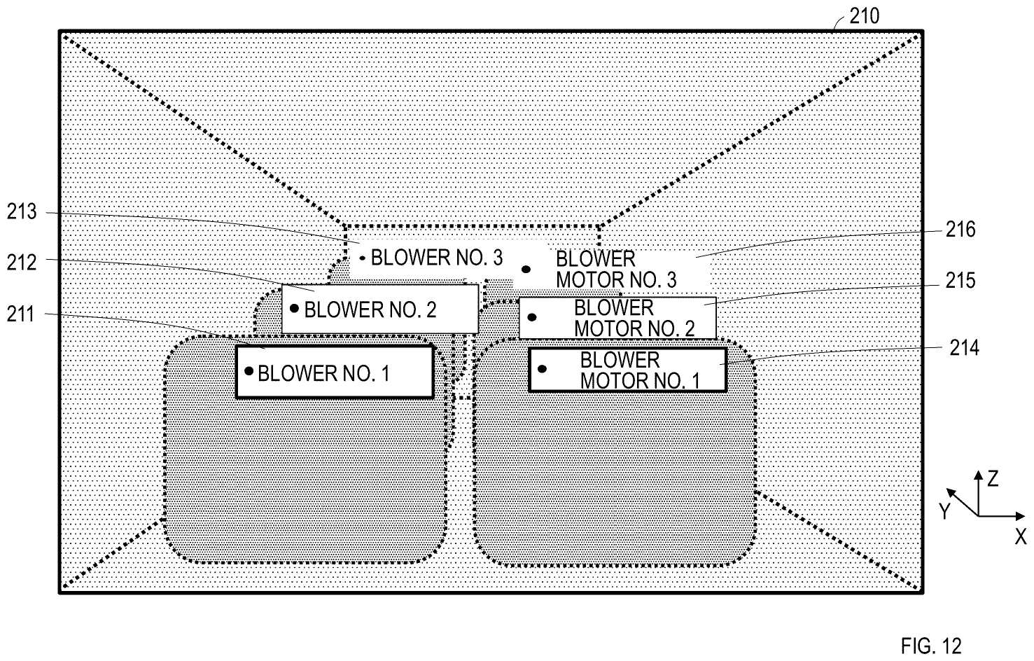

The display control unit 130 may control display of nameplate data based on a distance between a reference corresponding to projection information and a point with which the nameplate data is associated. “Reference corresponding to projection information” is a surface, line, point, and the like which serves as a reference for a distance to a point in point cloud data, and may be, for example, a plane which includes a viewpoint with the line-of-sight direction as a vertical line. Here, a “reference corresponding to projection information” may be appropriately changed depending on the structure of equipment. For example, a viewpoint itself may be used as a reference and nameplate data may be displayed based on a distance from the viewpoint. Alternatively, a vertical straight line passing through a viewpoint may be used as a reference and nameplate data may be displayed based on a distance from the straight line. FIG. 12 is a diagram illustrating an example in which a thickness of a frame surrounding nameplate data is changed depending on a distance. It is desirable to display nameplate data so that a user can be aware of a distance, and shading of nameplate data may be changed, or the size of nameplate data may be changed. A user can recognize a distance to a point associated with nameplate data and therefore, the user can easily understand a visible relationship between point cloud data and nameplate data when a plurality of pieces of nameplate data are displayed in the point cloud data.

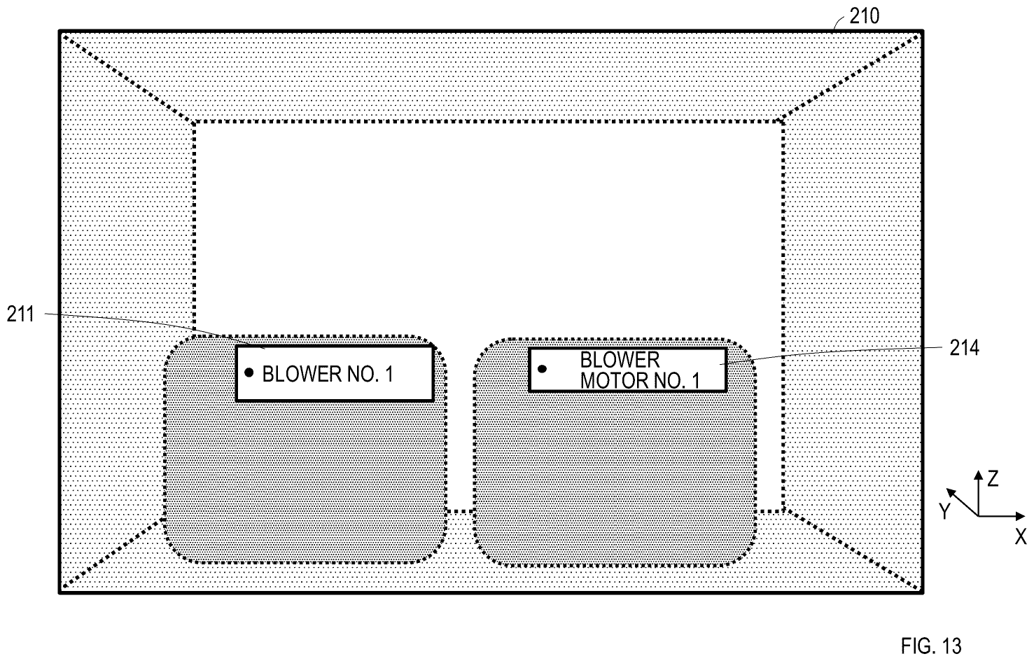

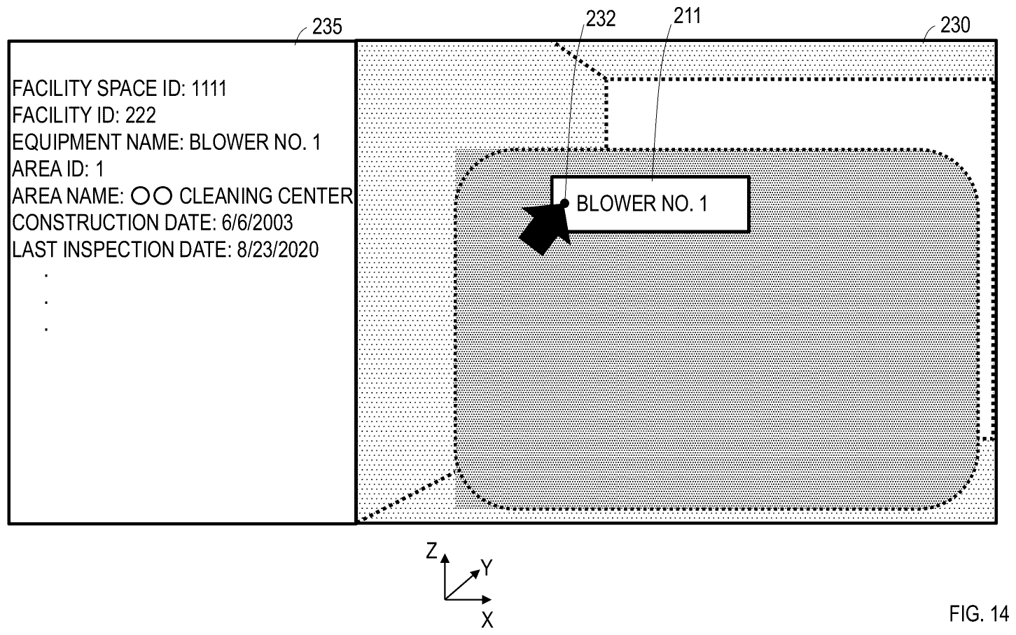

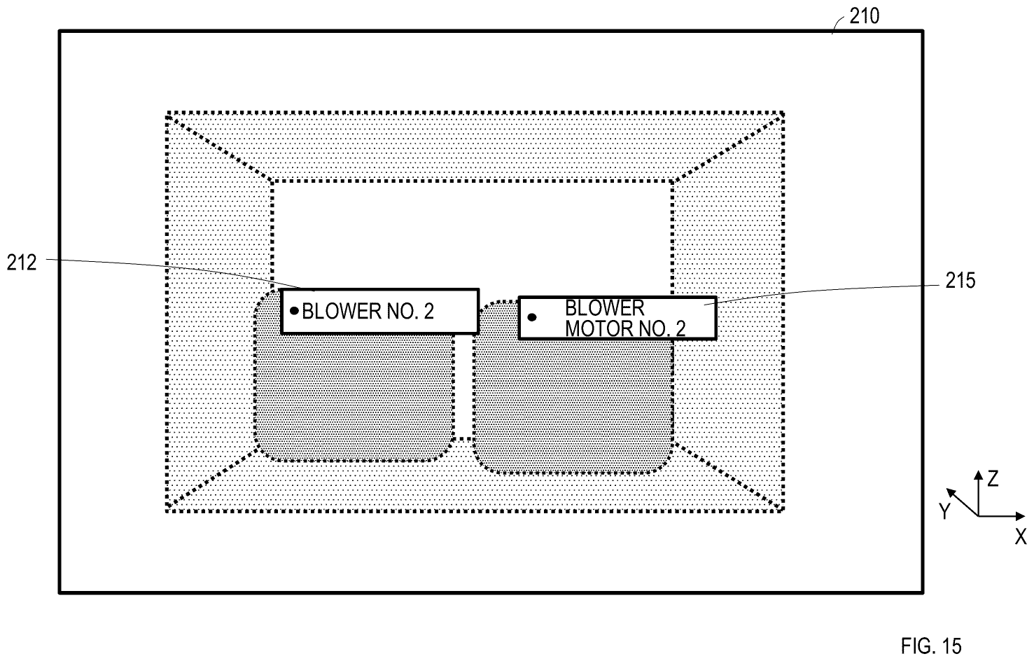

In step S131, the display control unit 130 may also acquire point cloud selection information which is a condition for selecting point cloud data which is to be displayed on the display unit 120. In this case, the display control unit 130 controls display of the point cloud data on the display unit 120 also in accordance with the point cloud selection information in step S132. “Point cloud selection information” may be, for example, a condition using a distance in the three-dimensional coordinate based on a reference corresponding to projection information. FIG. 13 is a diagram illustrating a state in which only point cloud data in FIG. 6 at close distances is displayed. FIG. 14 is a diagram illustrating a state in which only point cloud data in FIG. 8 at close distances is displayed. As can be seen from these diagrams, nameplate data associated with points which are not displayed as point cloud data are also not displayed. FIG. 15 is a diagram illustrating a state in which only point cloud data at an intermediate part is displayed. In FIG. 15, the point cloud data of Blower No. 1 and Blower Motor No. 1 have disappeared and therefore, Blower No. 2 and Blower Motor No. 2 are displayed so as to be visually recognized. The point cloud data of Blower No. 3 and Blower Motor No. 3 are also not displayed and therefore, the nameplate data 213 and 216 are also not displayed. By selecting and displaying point cloud data, nameplate data can also be selected, being able to more naturally ensure an integrated operation system between search-target equipment and a nameplate. It is also possible to select rear point cloud data which is hidden by front point cloud data, making it possible to identify individual pieces of equipment in the space.

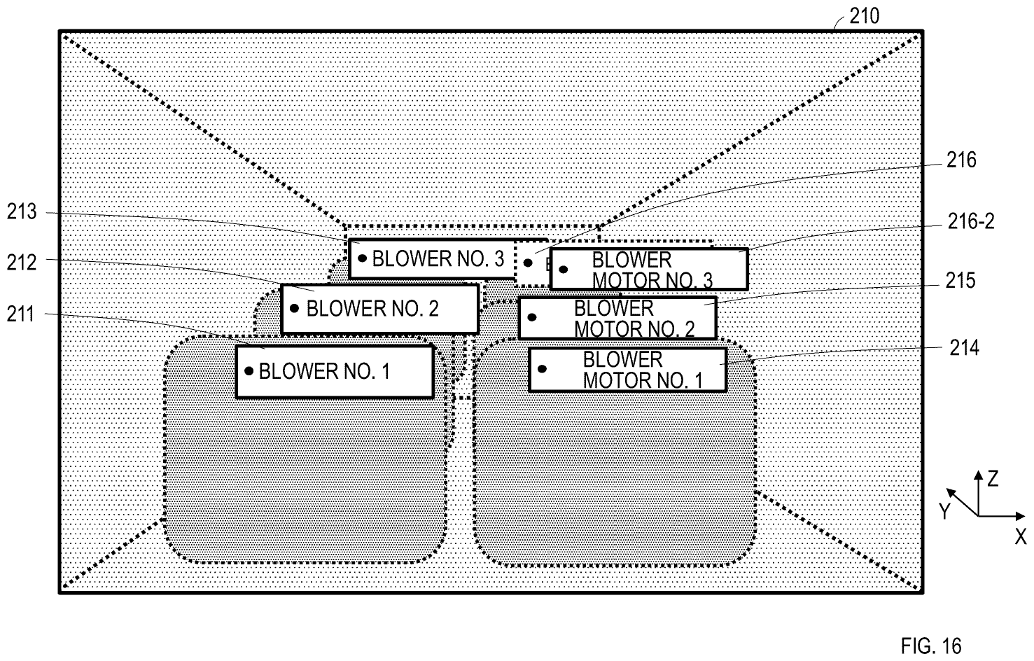

FIG. 16 is a diagram illustrating a state in which a point for associating nameplate data is changed. It can be seen that the nameplate data 216 of Blower Motor No. 3 has been moved to a position of nameplate data 216-2. When the association change unit 140 is provided, it is possible to move nameplate data to a position on which the nameplate data can be easily visually observed in a situation where pieces of nameplate data overlap each other. Further, the association change unit 140 changes a point with which nameplate data is associated to a point whose distance from the original point in the three-dimensional coordinate is within a predetermined distance, thereby being able to prevent the nameplate data from being associated with different management-target equipment.

According to the equipment management apparatus 100, in a state in which point cloud data is treated as a single set, nameplate data is associated with at least one point corresponding to management-target equipment. Thus, point cloud data and equipment information are easily associated with each other. In terms of display, point cloud data is displayed in a desired range from a desired direction and displayed based on a point with which nameplate data is associated. A load on the equipment management apparatus in displaying can be reduced and as a result, stress on a user can be reduced. Thus, operability of systems for managing management-target equipment such as infrastructure facilities by using three-dimensional point cloud data can be improved, being able to provide more advanced working environments.

### First Modification

FIG. 1 also illustrates a functional configuration example of an equipment management apparatus according to a first modification. An equipment management apparatus 100′ of the first modification is an equipment management apparatus for managing management-target equipment, which is equipment to be managed, by using point cloud data of a space including the management-target equipment. The equipment management apparatus 100′ includes at least the recording unit 190, the display unit 120, and a display control unit 130′. The equipment management apparatus 100′ may include an associating unit 110′ and an association change unit 140′. The associating unit 110 associates nameplate data of management-target equipment included in point cloud data with at least one point corresponding to the management-target equipment, in the equipment management apparatus 100 of the first embodiment. The associating unit 110′ associates nameplate data of management-target equipment included in point cloud data with a three-dimensional coordinate corresponding to at least one point corresponding to the management-target equipment, in the first modification (S110′). Therefore, the display control unit 130′ controls display of nameplate data on the display unit 120 based on a position at which a three-dimensional coordinate, with which the nameplate data is associated, is displayed on the display unit 120 in accordance with projection information (S133′). The following is a description of changes and parts related to the changes. Parts whose descriptions are omitted are the same as those in the first embodiment.

FIG. 2 illustrates an example of a processing flow of association assignment. The associating unit 110′ associates nameplate data of management-target equipment included in point cloud data with a three-dimensional coordinate corresponding to at least one point corresponding to the management-target equipment, in accordance with an instruction of a user of the corresponding equipment management apparatus (S110′). In step S110′, the user first selects nameplate data (S111). Subsequently, the user selects a point from the point cloud data displayed on the display unit 120 so as to associate the nameplate data with the three-dimensional coordinate of the point (S112′). As is the case with the first embodiment, for example, the point to be selected for association may be the closest point which exists within a predetermined range from a position (position on a screen of the display unit 120) designated by the user using a mouse or the like. Steps S111 and S112′ are executed with respect to nameplate data of all management-target equipment included in the point cloud data (S113). In principle, the number of points to be selected may be one. However, a plurality of points in the vicinity may be selected. When a plurality of points are selected, for example, the associating unit 110′ may obtain an average coordinate of coordinates of the selected points so as to associate nameplate data with a three-dimensional coordinate of the closest point or associate nameplate data with the average coordinate (three-dimensional coordinate).

The above-described processing is performed in the associating unit 110′ and therefore, nameplate data of management-target equipment included in point cloud data is recorded in the recording unit 190 in a manner to be associated with a three-dimensional coordinate corresponding to at least one point corresponding to the management-target equipment, as “information of a state in which the processing in the associating unit 110′ is completed”. That is, the recording unit 190 of the equipment management apparatus 100′ free from including the associating unit 110′ and the recording unit 190 of the equipment management apparatus 100′ in which the processing in the associating unit 110′ is completed record equipment information, which includes nameplate data for identifying management-target equipment existing in a space and attribute data indicating an attribute of the management-target equipment, and the point cloud data, which is a set of points having three-dimensional coordinates, and the nameplate data of the management-target equipment included in the point cloud data is associated with a three-dimensional coordinate corresponding to at least one point corresponding to the management-target equipment. In the present invention, it is sufficient for point cloud data to be a single set of points having three-dimensional coordinates, and there is no need to classify point cloud data for every management-target equipment. That is, nameplate data is associated with management-target equipment or a three-dimensional coordinate of the vicinity of the management-target equipment in the state in which the point cloud data is treated as a single set. Thus, point cloud data and equipment information are easily associated with each other.

FIG. 3 illustrates an example of a processing flow in a configuration in which the display unit 120 and the display control unit 130′ are provided. FIG. 4 illustrates an example of a processing flow in a configuration in which the display unit 120, the display control unit 130′, and the association change unit 140′ are provided. The display control unit 130′ acquires projection information which is a condition for two-dimensionally converting point cloud data so as to control display of the point cloud data on the display unit 120 in accordance with the projection information, and controls display of nameplate data on the display unit 120 based on a position at which a three-dimensional coordinate, with which the nameplate data is associated, is displayed on the display unit 120 in accordance with the projection information (S130′). The projection information may be information including, for example, a position of a viewpoint in a space (a viewpoint coordinate which is a three-dimensional coordinate of the viewpoint) and a line-of-sight direction which is a direction of a line of sight from the viewpoint. Point cloud data is two-dimensionally converted based on such projection information. The display unit 120 is provided with a display and so on and displays two-dimensionally converted point cloud data and nameplate data (S120). “Control display of nameplate data on the display unit 120 based on a position at which a three-dimensional coordinate, with which the nameplate data is associated, is displayed on the display unit 120 in accordance with the projection information” means that the position at which the nameplate data is displayed is based on a position at which the associated three-dimensional coordinate is displayed on the display unit 120. For example, nameplate data may be displayed on the display unit 120 so that a specific position of the nameplate data overlaps with a position at which a three-dimensional coordinate is displayed on the display unit 120. The nameplate data is displayed in this manner and therefore, it is easy for users to understand a correspondence relationship between management-target equipment and equipment information even though point cloud data is treated as a single set. Here, the display control unit 130′ may reduce the density of point cloud data to be displayed on the display unit 120 when projection information is changed. A risk of the equipment management apparatus 100′ being in a frozen state can be reduced. As a result, stress on users can be reduced.

In a configuration in which the equipment management apparatus 100′ is also provided with the association change unit 140′, when association change is selected in a state in which point cloud data and nameplate data are displayed on the display unit 120 (S141), the association change unit 140′ changes a three-dimensional coordinate, with which nameplate data is associated, to a three-dimensional coordinate whose distance in the three-dimensional coordinate is within a predefined distance (S142′). Even when a three-dimensional coordinate with which nameplate data is associated is changed, the three-dimensional coordinate needs to be changed to a three-dimensional coordinate around the same management-target equipment. Therefore, the three-dimensional coordinate may be changed to a three-dimensional coordinate whose distance in the three-dimensional coordinate is within a predetermined distance. The “predetermined distance” may be determined taking into account the dimensions of management-target equipment and a distance between adjacent points in point cloud data.

FIG. 5 is a diagram illustrating an example of a processing flow of the display control unit 130′. The display control unit 130′ acquires projection information which is a condition for two-dimensionally converting point cloud data (S131). The display control unit 130′ controls display of the point cloud data on the display unit 120 in accordance with the projection information (S132). Then, the display control unit 130′ may two-dimensionally convert the point cloud data so as to represent an appearance viewed from the viewpoint in the line-of-sight direction. Further, the display control unit 130′ controls display of nameplate data on the display unit 120 based on a position at which a three-dimensional coordinate, with which the nameplate data is associated, is displayed on the display unit 120 in accordance with projection information (S133′). The display control unit 130′ displays the nameplate data as two-dimensional data so that the nameplate data is not hidden by the point cloud data. For example, the display control unit 130′ two-dimensionally projects the point cloud data on the display unit 120 in step S132 and then overwrites the nameplate data as two-dimensional data in step S133′, thereby being able to display the nameplate data so that the nameplate data is not hidden by the point cloud data.

Also in the equipment management apparatus 100′, the display control unit 130′ may also acquire nameplate selection information which is a condition for selecting nameplate data which is to be displayed on the display unit 120, in step S131. When nameplate selection information is also acquired, the display control unit 130′ controls display of the nameplate data on the display unit 120 also in accordance with the nameplate selection information in step S133′. FIG. 11 illustrates a state in which nameplate data is selected and displayed. The point cloud data 210 is the same as in FIG. 6, but only the nameplate data 211 and 214 are illustrated. For example, when point cloud data cannot be visually observed as in FIG. 8, it is possible to select not to display the nameplate data of management-target equipment which cannot be visually observed.

The display control unit 130′ may control display of nameplate data based on a distance between a reference corresponding to projection information and a three-dimensional coordinate with which the nameplate data is associated. “Reference corresponding to projection information” is a surface, line, point, and the like which serves as a reference for a distance to a point in point cloud data, and may be, for example, a plane which includes a viewpoint with the line-of-sight direction as a vertical line. Here, a “reference corresponding to projection information” may be appropriately changed depending on the structure of equipment. For example, a viewpoint itself may be used as a reference and nameplate data may be displayed based on a distance from the viewpoint. Alternatively, a vertical straight line passing through a viewpoint may be used as a reference and nameplate data may be displayed based on a distance from the straight line. FIG. 12 is a diagram illustrating an example in which a thickness of a frame surrounding nameplate data is changed depending on a distance. It is desirable to display nameplate data so that a user can be aware of a distance, and shading of nameplate data may be changed, or the size of nameplate data may be changed. A user can recognize a distance to a point associated with nameplate data and therefore, the user can easily understand a visible relationship between point cloud data and nameplate data when a plurality of pieces of nameplate data are displayed in the point cloud data.

Also in the equipment management apparatus 100′, the display control unit 130′ may also acquire point cloud selection information which is a condition for selecting point cloud data which is to be displayed on the display unit 120, in step S131. In this case, the display control unit 130′ controls display of the point cloud data on the display unit 120 also in accordance with the point cloud selection information in step S132. Further, the display control unit 130′ controls display of nameplate data on the display unit 120 in accordance with the point cloud selection information, in step S133′. Specifically, the display control unit 130′ may display nameplate data only when a three-dimensional coordinate with which the nameplate data is associated falls within a range selected in the point cloud selection information. That is, the display control unit 130′ controls display of point cloud data on the display unit 120 and display of nameplate data on the display unit 120 also in accordance with the point cloud selection information (S132, S133′). “Point cloud selection information” may be, for example, a condition using a distance in the three-dimensional coordinate based on a reference corresponding to projection information. FIG. 13 is a diagram illustrating a state in which only point cloud data in FIG. 6 at close distances is displayed. FIG. 14 is a diagram illustrating a state in which only point cloud data in FIG. 8 at close distances is displayed. As can be seen from these diagrams, nameplate data associated with three-dimensional coordinates which are not selected as point cloud data are also not displayed. FIG. 15 is a diagram illustrating a state in which only point cloud data at an intermediate part is displayed. In FIG. 15, the point cloud data of Blower No. 1 and Blower Motor No. 1 have disappeared and therefore, Blower No. 2 and Blower Motor No. 2 are displayed so as to be visually recognized. The point cloud data of Blower No. 3 and Blower Motor No. 3 are also not displayed and therefore, the nameplate data 213 and 216 are also not displayed. By selecting and displaying point cloud data, nameplate data can also be selected, being able to more naturally ensure an integrated operation system between search-target equipment and a nameplate. It is also possible to select rear point cloud data which is hidden by front point cloud data, making it possible to identify individual pieces of equipment in the space.

According to the equipment management apparatus 100′, in a state in which point cloud data is treated as a single set, nameplate data is associated with a three-dimensional coordinate which is one point corresponding to management-target equipment. Thus, point cloud data and equipment information are easily associated with each other. In terms of display, point cloud data is displayed in a desired range from a desired direction and displayed based on a three-dimensional coordinate with which nameplate data is associated. A load on the equipment management apparatus in displaying can be reduced and as a result, stress on a user can be reduced. Thus, operability of systems for managing management-target equipment such as infrastructure facilities by using three-dimensional point cloud data can be improved, being able to provide more advanced working environments.

### Program and Recording Medium

The functions realized by the components described in the present specification may be implemented in circuitry or processing circuitry, including general-purpose processors, application specific processors, integrated circuits, application specific integrated circuits (ASICs), central processing units (CPUs), conventional circuits, and/or combinations thereof, which are programmed to realize the described functions. Processors include transistors and other circuits and are considered to be circuitry or processing circuitry. A processor may be a programmed processor which executes a program stored in a memory.

In the present specification, a circuitry, unit, and means are hardware which are programmed to realize the described functions or execute the described functions. The hardware may be any hardware disclosed in the present specification or any hardware programmed to realize the described functions or known to execute the described functions.

If the hardware is a processor which is considered to be a circuitry type, the circuitry, means, or unit is a combination of the hardware and the software used to configure the hardware and/or the processor.

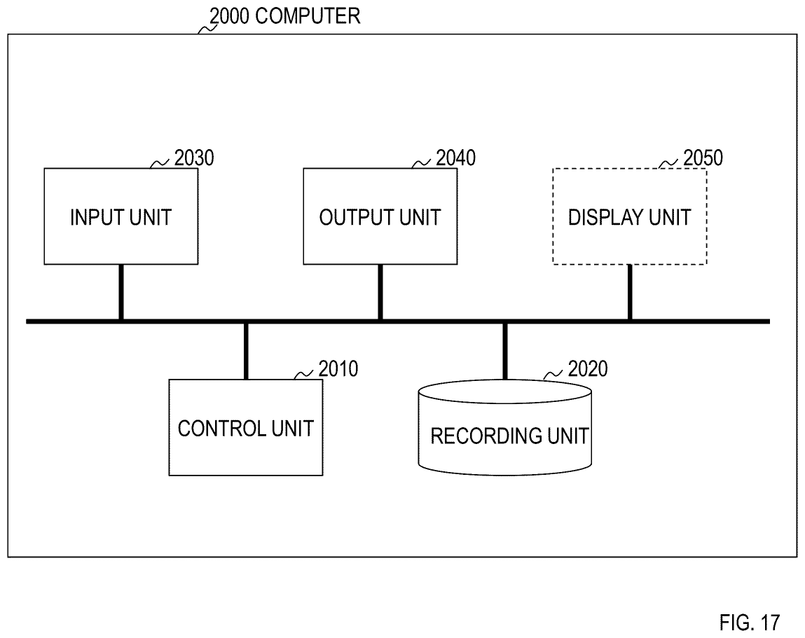

The above-described various types of processing can be performed by allowing a recording unit 2020 of a computer 2000 illustrated in FIG. 17 to read a program for execution of each step of the above-described method and allowing a control unit 2010, an input unit 2030, an output unit 2040, a display unit 2050, and the like to operate.

The program describing the processing details can be recorded on a computer-readable recording medium. The computer-readable recording medium may be any kind, such as a magnetic recording device, an optical disk, a magneto-optical recording medium, or a semiconductor memory.

Also, the distribution of this program is performed by, for example, selling, transferring, or lending a portable recording medium such as a DVD or a CD-ROM on which the program is recorded. Furthermore, a configuration may be adopted in which this program is distributed by storing the program in a storage device of a server computer and transferring the program to other computers from the server computer via a network.

The computer that executes such a program first, for example, temporarily stores the program recorded on the portable recording medium or the program transferred from the server computer in a storage device thereof. At the time of execution of processing, the computer then reads the program stored in the storage device thereof and executes the processing in accordance with the read program. Also, as another form of execution of this program, the computer may read the program directly from the portable recording medium and execute the processing in accordance with the program and, furthermore, every time the program is transferred to the computer from the server computer, the computer may sequentially execute the processing in accordance with the received program. Also, a configuration may be adopted in which the transfer of a program to the computer from the server computer is not performed and the above-described processing is executed by so-called application service provider (ASP)-type service by which the processing functions are implemented only by an instruction for execution thereof and result acquisition. Furthermore, a configuration may be adopted in which terminal processing is executed by using so-called software as a service (SaaS)-type service that causes a user to use part of a server computer together with a program. Note that a program in this form shall encompass information that is used in processing by an electronic computer and acts like a program (such as data that is not a direct command to a computer but has properties prescribing computer processing).

Further, although the present device was described as being configured via execution of a predetermined program on a computer in this form, at least some of these processing details may instead be embodied with hardware.

### DESCRIPTION OF REFERENCE NUMERALS

100, 100′ equipment management device
110, 110′ associating unit
120 display unit
130, 130′ display control unit
140, 140′ association change unit
190 recording unit
210, 220, 230, 240, 250 point cloud data
211 to 216 nameplate data
231 point
235 attribute data

1. An equipment management apparatus for managing management-target equipment, the management-target equipment being equipment to be managed, by using point cloud data of a space including the management-target equipment, the equipment management apparatus comprising:
a recording device which records equipment information, the equipment information including nameplate data for identifying management-target equipment existing in the space and attribute data indicating an attribute of the management-target equipment, and the point cloud data, the point cloud data being a set of points each having a three-dimensional coordinate;
a display device which displays point cloud data and nameplate data; and
a display control processor which acquires projection information, the projection information being a condition for two-dimensionally converting the point cloud data, so as to control display of the point cloud data on the display device in accordance with the projection information, and controls display of the nameplate data on the display device, wherein
the recording device records the nameplate data in a manner to associate the nameplate data to a point in the point cloud data or a three-dimensional coordinate, and
when the nameplate data is associated with a point in the point cloud data, the display control processor controls display of the nameplate data on the display device based on a position at which the point in the point cloud data, with which the nameplate data is associated, is displayed on the display device, and when the nameplate data is associated with a three-dimensional coordinate, the display control processor controls display of the nameplate data on the display device based on a position at which the three-dimensional coordinate, with which the nameplate data is associated, is displayed on the display device in accordance with the projection information.

2. The equipment management apparatus according to claim 1, further comprising:
an associating processor which associates nameplate data of management-target equipment included in the point cloud data with a three-dimensional coordinate corresponding to at least one point corresponding to the management-target equipment.

3. The equipment management apparatus according to claim 1, wherein
the display control processor displays the nameplate data as two-dimensional data so that the nameplate data is not hidden by the point cloud data.

4. The equipment management apparatus according to claim 1, wherein
the display control processor also acquires point cloud selection information, the point cloud selection information being a condition for selecting point cloud data to be displayed on the display device, and controls display of the point cloud data on the display device also in accordance with the point cloud selection information.

5. The equipment management apparatus according to claim 1, wherein
the display control processor also acquires point cloud selection information, the point cloud selection information being a condition for selecting point cloud data to be displayed on the display device, and controls display of the point cloud data on the display device and display of the nameplate data on the display device also in accordance with the point cloud selection information.

6. The equipment management apparatus according to claim 1, wherein
the display control processor also acquires nameplate selection information, the nameplate selection information being a condition for selecting nameplate data to be displayed on the display device, and controls display of the nameplate data on the display device also in accordance with the nameplate selection information.

7. The equipment management apparatus according to claim 1, wherein
the projection information is information including a position of a viewpoint in the space and a line-of-sight direction, the line-of-sight direction being a direction of a line of sight from the viewpoint.

8. The equipment management apparatus according to claim 1, wherein
when the nameplate data is associated with a point in the point cloud data, the display control processor controls display of the nameplate data based on a distance between a reference corresponding to the projection information and the point with which the nameplate data is associated, and when the nameplate data is associated with a three-dimensional coordinate, the display control processor controls display of the nameplate data based on a distance to the three-dimensional coordinate with which the nameplate data is associated.

9. The equipment management apparatus according to claim 1, wherein
the point cloud selection information is a condition using a distance in a three-dimensional coordinate based on a reference corresponding to the projection information.

10. The equipment management apparatus according to claim 1, further comprising:
an association change processor which, when the nameplate data is associated with a point in the point cloud data, changes a point with which the nameplate data is to be associated to a point whose distance from the point in a three-dimensional coordinate is within a predetermined distance.

11. The equipment management apparatus according to claim 1, further comprising:
an association change processor which, when the nameplate data is associated with a three-dimensional coordinate, changes a three-dimensional coordinate with which the nameplate data is to be associated to a three-dimensional coordinate whose distance in the three-dimensional coordinate is within a predetermined distance.

12. An equipment management method using an equipment management apparatus for managing management-target equipment, the management-target equipment being equipment to be managed, by using point cloud data of a space including the management-target equipment,
the equipment management apparatus including a recording device, a display device, and a display control processor,
where equipment information and the point cloud data are recorded in the recording device in advance, the equipment information including nameplate data for identifying management-target equipment existing in the space and attribute data indicating an attribute of the management-target equipment, the point cloud data being a set of points each having a three-dimensional coordinate,
the equipment management method comprising:
a display control in which the display control processor acquires projection information, the projection information being a condition for two-dimensionally converting the point cloud data, so as to control display of the point cloud data on the display device in accordance with the projection information, and controls display of the nameplate data on the display device, wherein
the recording device records the nameplate data in a manner to associate the nameplate data to a point in the point cloud data or a three-dimensional coordinate, and
in the display control, when the nameplate data is associated with a point in the point cloud data, display of the nameplate data on the display device is controlled based on a position at which the point in the point cloud data, with which the nameplate data is associated, is displayed on the display device, and when the nameplate data is associated with a three-dimensional coordinate, display of the nameplate data on the display device is controlled based on a position at which the three-dimensional coordinate, with which the nameplate data is associated, is displayed on the display device in accordance with the projection information.

13. The equipment management method according to claim 12,
where the equipment management apparatus also includes an associating processor,
the equipment management method further comprising:
an associating in which nameplate data of management-target equipment included in the point cloud data is associated with at least one point corresponding to the management-target equipment by using the associating processor.

14. The equipment management method according to claim 12, wherein
in the display control, when the nameplate data is associated with a point in the point cloud data, display of the nameplate data is controlled based on a distance between a reference corresponding to the projection information and the point with which the nameplate data is associated, and when the nameplate data is associated with a three-dimensional coordinate, display of the nameplate data is controlled based on a distance to the three-dimensional coordinate with which the nameplate data is associated.

15. The equipment management method according to claim 12, wherein
the point cloud selection information is a condition using a distance in a three-dimensional coordinate based on a reference corresponding to the projection information.

16. The equipment management method according to claim 12,
where the equipment management apparatus also includes an association change processor,
the equipment management method comprising:
an association change in which when the nameplate data is associated with a point in the point cloud data, the association change processor changes a point with which the nameplate data is to be associated to a point whose distance from the point in a three-dimensional coordinate is within a predetermined distance.

17. The equipment management method according to claim 12,
where the equipment management apparatus also includes an association change processor,
the equipment management method comprising:
an association change in which when the nameplate data is associated with a three-dimensional coordinate, the association change processor changes a three-dimensional coordinate with which the nameplate data is to be associated to a three-dimensional coordinate whose distance in the three-dimensional coordinate is within a predetermined distance.

18. (Canceled)

19. A non-transitory computer readable medium in which an equipment management program for making a computer function as the equipment management apparatus according to claim 1 is recorded.
